(19) United States
(12) Patent Application Publication
(10) Pub. No.: US 2010/0217950 A1
(43) Pub. Date: Aug. 26, 2010

(54) COMPUTER APPARATUS AND CONTROL METHOD

(75) Inventors: Youji TANAKA, Zama (JP); Eiichiro OIWA, Tone (JP); Naoya HATTORI, Kokubunji (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/623,507

(22) Filed: Nov. 23, 2009

(30) Foreign Application Priority Data
Feb. 26, 2009 (JP) 2009-043331

(51) Int. Cl. G06F 12/10; G06F 12/00; G06F 12/14

(52) U.S. Cl. 711/206; 711/203; 711/214; 711/E12.001; 711/E12.093; 711/E12.059; 711/163

(57) ABSTRACT

A computer system with a physical computer having a physical processor, physical memory, virtual computer and virtual computer controller is disclosed. The virtual computer has its own processor and memory, which are virtual components that are provided by logically dividing the physical processor and memory, respectively. The virtual computer also has a page table storing a physical/virtual memory address correspondence relationship, and a protection object table for address management of a protected address space in the virtual memory. The controller includes a protection exception processing unit, protection exception save region, virtual/physical memory address converter, and instruction analyzer. Upon execution of protection exception processing, the controller compares an instruction address at which was generated the protection exception processing to an instruction address of protection exception information saved. If these are identical, a pseudo-instruction is used to execute the protection exception processing, thereby reducing the total processing amount required.

### INCORPORATION BY REFERENCE

The present application claims priority from Japanese application JP2009-043331 filed on Feb. 26, 2009, the content of which is hereby incorporated by reference into this application.

### BACKGROUND OF THE INVENTION

The present invention relates to pseudo-instructions to be executed on a physical computer apparatus in virtual computer environments, and also relates to a method for enhancing speed performances of instruction read event-associated virtual address (referred to as “linear address” hereinafter) and physical address conversion processing and instruction analysis processing.

In recent years, an increase in number of elements integratable on an integrated circuit chip and advance in high-density mounting/packaging technology for coupling them together result in the tendency of increases in number of computing resources, such as processors, input/output (I/O) devices and storage capacity of memory, which are put in the casing chassis of one physical computer. The technique for coupling together the chassises of a plurality of physical computers by a network to thereby handle them as a single physical computer is also being advanced—with this advance, the computation resources that are received in one physical computer tend to further increase in number. This type of physical computer with a great number of computation resources being packed together in one physical computer requires much time before it becomes usable after electrical power activation, when compared to a physical computer which is less in number of computation resources. For this reason, it is a preferred tendency that the physical computer is continuously set in its power-activated state at all times.

In order to use this large-scale physical computer efficiently, a technique for performing logical zone partition—i.e., logical partitioning (LPAR), which is a method of virtually dividing one physical computer's resource into a plurality of portions—to thereby constitute a virtual computer system is becoming widely used. A respective one of the logically partitioned zones is for use as a virtual computer, which enables a chosen operating system (OS) to operate thereon independently. The physical computer to be subjected to such logical partitioning is set in the power-on state at all times, and each logical partitioned zone functions as an “independent” virtual computer the power of which can be turned on and off in a quasi-operation way. Applying the logical partitioning technology in this way makes it possible to improve the use efficiency and usability of node resources even in the large-scale physical computer.

The virtual computer system of the type stated above is needed to have a virtual computer control unit, which may be a software program for controlling the virtual computer system, in order to permit a virtual computer to offer the operation independency between itself and other virtual computers within the same physical computer.

This virtual computer control unit is required to provide the independent virtual computer with control and virtualization functions for dividing each of built-in processors and I/O devices of the physical computer into more than two portions which are usable exclusively or usable in a shared manner. In addition, in order to allow each virtual computer to use an independent memory space, the virtual computer control unit is also required to provide address conversion and setup functions for converting an address with respect to a physical memory space on a virtual computer which is recognized by the virtual computer as a physical memory (the memory space will be referred to as a virtual computer physical memory hereinafter) into an address of the physical memory (referred to hereinafter as physical address).

In general, the OS establishes a virtual memory space which is different from the physical memory space. The OS and a process operating on this OS perform memory-handling operations by designating an address (linear address) of the virtual memory space. A central processing unit (CPU) has multi-stage page table (PT) functionality. This PT function is a memory management method of defining the correspondence between a prior-to-conversion address (linear address) and a converted address (physical address), as the function of performing memory protection and address conversion between virtual and physical memory spaces.

In the PT, first of all, there is an address which becomes the base of PT. This address designates an uppermost-level table. For this table, one part of a linear address becomes an index and designates a part within this table. The designated part contains therein an address of the next table, and this address is used to access the table for reference or “consultation” purposes. In the next table also, one part of a linear address becomes an index for designating one part within the table in a similar way. The structure with tables being queued in this way is called the PT. By repeating the above-stated operation for the PT, it is possible for the linear address to uniquely designate, without fail, a specific address within a table at the final stage. When the OS provides access to the physical memory, this PT's identical conversion is utilized to designate a linear address to thereby access the physical memory space.

The virtual computer control unit divides the physical memory space to create a plurality of partitioned physical memory spaces in units of virtual computers and allocates these memory spaces to the virtual computers, respectively. It is noted here that the physical memory space allocated to each virtual computer is created while assuming the use of a physical memory which causes the OS on virtual computer to regard an address zero (0) as a base point, although the address “0” is not always the base point in the physical memory space. In view of this, the virtual computer control unit prepares a memory space which defines each virtual computer's assumed address “0” as the base point, and uses it as the virtual computer physical memory space. A process to be created by virtual computer operates with this virtual computer physical memory space being as a reference so that all of information items within the tables of the PT which are generated on virtual computers are held by means of virtual computer physical addresses.

In cases where a virtual computer reads the physical memory from the virtual computer physical memory space by use of such virtual computer physical addresses, it is necessary to convert a virtual computer physical address into its corresponding physical address of the physical memory space and then gain access to the physical memory. More specifically, when accessing the virtual computer physical memory space for use with the virtual computer, the OS on such virtual computer and the process that operates on this OS are supposed to read the PT of virtual computer from a linear address and convert, whenever one table of PT is read, it into a physical address corresponding to the virtual computer physical address to thereby calculate a final physical address, thus accessing the physical memory.

Typically, an instruction which is issued by the CPU is a string of binary codes at those values that are stored in the physical memory space. In order for the virtual computer control unit to execute a pseudo-instruction of the instruction which is issued by the OS or a program on the virtual computer, it becomes necessary to perform command/instruction analysis for analyzing this instruction binary code string to make meaningful information including, but not limited to, a command type, command parameter(s) and command length. To do this, a need is felt to design the virtual computer control unit in such a way as to realize instruction analysis functionality which is pursuant to the CPU's architecture and pattern matching of every instruction owned by the CPU.

Also note that the above-stated device virtualization necessitates the use of a processor capable of protecting a specific address space. The processor having the protection function is such that when the reading or writing of a protected region (referred to hereinafter as protection region) of the access space is performed, an exception takes place; so, an exception processing program of the virtual computer control unit is executed. By the protection exception processing program for this protection exception, the device virtualization is realized. The protection exception processing program provides control for realizing a virtual device by specifying an instruction which has performed the read/write and executing in a quasi-operation manner an operation which is similar to that in the case of such instruction being executed by the physical computer.

Prior known techniques relating to the above-stated virtual device realization control technology are disclosed, for example, in JP-A-2003-167758 and JP-A-2006-085543.

In a certain type of processor, a register of an interrupt processing device is allocated to an address area (physical frame) which is defined within a physical memory address space. By performing reading or writing of the individual allocated address, the register read/write is performed. In case an interrupt device is virtualized, a process is performed which includes the steps of correlating a physical frame to which is allocated the register of interrupt device with an access protection-capable virtual computer physical address region (page), handling this page as an object to be protected, and causing one part of the read/write exception processing to be processed by the virtual computer control unit. With this processing of the exception, the interrupt processor device is virtualized.

Accordingly, the register read/write of the interrupt processor device necessitates the exception processing for specifying an instruction that has performed such read/write and for virtually executing the read/write instruction. A register which is used to report that the interrupt processing program has completed its interrupt processing, also, is a device which is allocated to this protection region; thus, similar instruction specifying processing and pseudo-instruction executing processing are necessary.

### SUMMARY OF THE INVENTION

As has been stated above, prior art techniques based on the control method for allocating a register(s) to the protection region and for performing device virtualization by the protection exception processing are strictly required to perform the specifying of a physical computer-use physical address from the linear address of an instruction on a virtual computer that became the exception generation cause and the instruction analysis from the binary code of the instruction and also the processing for virtually executing an operation which is similar to that in the case of such instruction being executed by the physical computer, and therefore suffer from a problem of unwanted increase in processing amount when compared to those devices that are not virtualized. Additionally, the above-stated prior art techniques are faced with the occurrence of a problem which follows: in the case of virtualization of a device with a use frequency-increased register becoming the protection object (e.g., the interrupt processor device stated supra), the protection exception processing thereof increases to the extent that its increase is no longer ignorable relative to the processing amount of the whole system.

To solve the above-stated problems, a computer apparatus and control methodology in accordance with this invention are such that the computer apparatus includes one or more than one physical processor, a physical memory, a virtual computer which logically divides the physical processor and the physical memory and uses divided ones as a virtual processor and a virtual computer physical memory, and a virtual computer control unit for controlling the virtual computer. The virtual computer comprises the virtual processor, the virtual computer physical memory, a page table having a correspondence relationship of address information of an address space of the virtual computer physical memory and address information of an address space of the physical memory, and a protection object table for management of address information of a presently protected address space in the address space of the virtual computer physical memory. The virtual computer control unit includes a protection exception processing unit for executing protection exception processing in a case where access is given to the address space being managed by the protection object table, a protection exception save region for storing therein protection exception information concerning the protection exception processing executed, an address conversion unit for converting an address of the virtual computer physical memory and an address of the physical memory, and an instruction analysis unit. Upon execution of the protection exception processing, the protection exception processing unit compares an instruction address which generated the protection exception processing and an instruction address of protection exception information saved in the protection exception save region and, when the instruction address which generated the protection exception processing and the instruction address of the protection exception information coincide with each other, the protection exception processing unit uses a pseudo-instruction which is stored or included in the protection exception information of the coincided instruction address to execute the protection exception processing.

More specifically, according to this invention, in a virtual computer system in which are arranged two or more virtual computers that commonly use or “share” at least one central processing unit (CPU) and a memory for executing a plurality of software programs in a switchable way, the system has a virtual computer control means for controlling the virtual computers. The virtual computer control means has a protection object holding means which stores therein a protection object address for determination of whether an exception is generated or not and a protection exception saving means for storing a reusable pseudo-instruction which is optimized for protection exception processing. When a program which is executed by the CPU performs reading or writing with respect to a specific address region, a process is executed which includes the steps of making reference to the protection object holding means to thereby determine whether the protection exception processing is executed or not, and, in a case where the protection exception processing is executed, comparing together an instruction address within protection exception information and an address of the instruction which became the cause for generation of the protection exception processing to thereby determine whether the protection exception information due to the address that became the cause of protection exception is present in the protection exception saving means which stores therein the above-stated reusable pseudo-instruction that was optimized for the protection exception processing.

In a case where the instruction address-coincided protection exception information does not exist in the protection exception save region, in the process of calculating a physical address of the instruction address (linear address), the processing for converting a virtual computer-use physical address into a physical address is performed, once at a time, whenever an attempt is made to reference each table of a multi-stage table of PT; an instruction which was read out of the calculated physical address is subjected to instruction analysis; then, a pseudo-instruction which was obtained by the instruction analysis is used to perform the protection exception processing. In this event, the information of the address conversion that was performed while reference is made to the multi-stage table and the analysis information of the instruction are held in the protection exception save region as protection exception information.

Alternatively, in a case where the instruction address-coincided protection exception information exists in the protection exception save region, in the process of computing a PT-used physical address from the instruction address (linear address) by using the PT, the conversion processing of a virtual computer-use physical address to a physical address is omitted by using conversion information within the protection exception information, and then determine whether the instruction that was read out of the physical address coincides with the instruction within the protection exception information. By doing so, any possible overhead of the instruction analysis disappears; then, the protection exception processing is executed using the pseudo-instruction that is held in the protection exception information. By omitting the conversion processing and suppressing the overhead in this way, the processing amount of the protection exception processing is reduced.

According to this invention, it becomes possible by a device operation(s) at the physical computer to reduce the overhead at a physical computer-use physical address from a virtual computer-use virtual computer physical address of an instruction and also task amounts of the pseudo-instruction processing and instruction analysis processing, thereby making it possible to realize a processing speed-improved virtual computer system and a control method thereof.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a virtual computer system incorporating the principles of this invention.

FIG. 2 is a block diagram showing configurations of a virtual computer and a virtual computer control unit in this invention.

FIG. 3 is a pictorial diagram showing a relationship between a protection exception saving region and protection exception information.

FIG. 4 is a diagram for explanation of an operation for holding the information of protection exception processing in the protection exception information.

FIG. 5 is a diagram for explanation of an operation which executes the protection exception processing by use of the protection exception information saved.

FIG. 6 is a flow chart of the operations shown in FIGS. 4 and 5.

### DETAILED DESCRIPTION OF THE INVENTION

Currently preferred embodiment of a virtual computer system and a control method of the virtual computer system incorporating the principles of this invention will be described with reference to the accompanying figures of the drawing below.

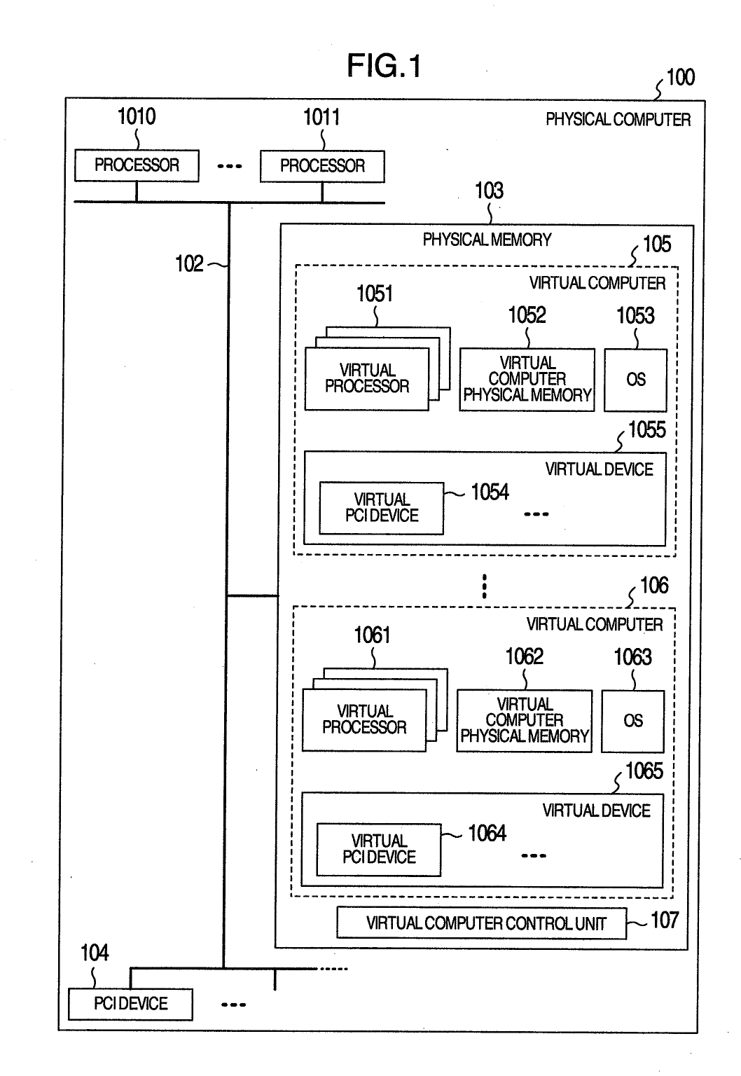

FIG. 1 is a block diagram showing a configuration of the virtual computer system in accordance with one embodiment of this invention. The system shown in FIG. 1 is the one that shows a configuration of a physical computer 100 in which a plurality of virtual computers and a virtual computer control unit are arranged to operate.

The physical computer 100 has a plurality of built-in processors 1010 to 1011. Any given number of processors may be provided in this physical computer as far as one or more than one processor is put therein. These processors 1010-1011 are connected by a bus 102 to a physical memory 103 and a peripheral component interconnect (PCI) device 104. The physical memory 103 stores therein software programs operable on a virtual computer control unit 107 and virtual computers 105 and 106.

The virtual computers 105-106 which are arranged in the physical computer 100 are controlled by the virtual computer control unit 107. On each virtual computer 105, 106, an operating system (OS) 1053, 1063 is operable independently. The virtual computer 105, 106 is configured from a virtual device 1055, 1065, such as a virtual PCI device 1054, 1064. In the case of the PCI device 1054, 1064 for example, the virtual device performs operations which are equivalent for the OS 1053, 1063 which operates on each virtual computer 105, 106 to operations of the PCI device 104 which is provided in the physical computer 100. The virtual computer 105, 106 is arranged to have a virtual processor 1051, 1061, a virtual computer-use physical memory 1052, 1062, and a virtual device 1055, 1065.

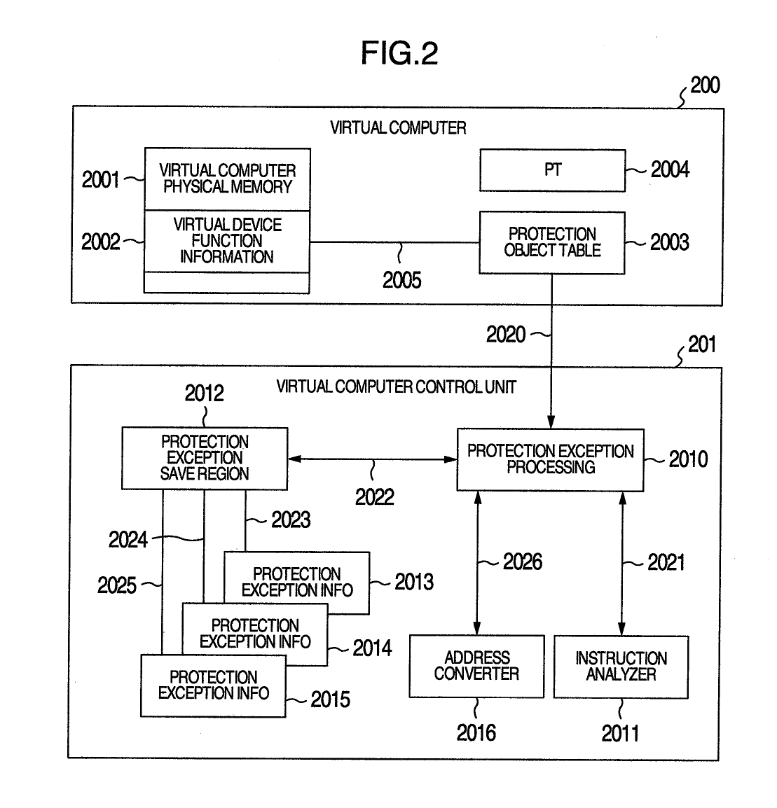

FIG. 2 is a diagram for explanation of a virtual computer realization program. This program will next be explained below.

A virtual computer 200 which is arranged in the physical computer 100 is controlled by a virtual computer control unit 201.

In the virtual computer 200, the information of a page table (PT) 2004 is held, which uses a virtual computer physical address that is provided by the processor as a mechanism for performing the address conversion and memory protection in the way stated supra. Function information 2002 of a virtual device, such as the above-stated virtual PCI device or the like, is added the correspondence to the address of a virtual computer physical memory 2001, which is allocated to the virtual computer control unit 201.

The virtual computer 200 also has information of a protection object table 2003 which is to be provided by the processor, for determining whether the allocated address is for use as a protection object address and for defining it in the protection object table (this process is indicated by line 2005 in FIG. 2). When a program which operates on the virtual computer makes reference to the virtual device which is allocated at the address that becomes a protection object in the protection object table, a protection exception interruption is caused to generate (as indicated by line 2020). By this process, it calls up protection exception processing 2010 of the virtual computer control unit 201.

The virtual computer control unit 201 is realized by a virtual computer control program which was loaded into the physical memory 103 of the physical computer 100, and is the one that controls the virtual computer 105, 106.

In addition to the protection exception processing 2010 that performs the processing of a protection exception interruption, the virtual computer control unit 201 has a protection exception save region 2012 for storing reusable pseudo-instructions as protection exception information 2013 to 2015 (as indicated by lines 2023 to 2025). The virtual computer control unit 201 also has an address conversion unit 2016 for conversion between an address of virtual computer physical memory and a physical address, and a command/instruction analysis unit 2011 which analyzes to determine that the exception information that was noticed to the protection exception processing was called up by what instruction. These are called up in several events, such as when the protection exception processing 2010 attempts to refer to the protection exception information (see arrow 2022 in FIG. 2), when performing analysis to specify that the protection exception is what instruction (2021), and when converting the address of the virtual computer physical memory into a physical address (2026).

Although almost all of the instructions for execution of the OS on the virtual computer 200 and a process operating on the OS are directly executed on the virtual computer 200, a privilege instruction for operating a control register on the virtual computer 200 and an instruction for operating the virtual computer physical memory 2001 that is allocated to the virtual device in the above-stated way are such that the virtual computer control unit 201 is called up in the event of execution of these instructions and is forced to execute them alternatively. This is because of the fact that it is impossible for a respective one on each virtual computer to freely manipulate the control register that also concerns the control of the physical computer and a virtual device which is used on a plurality of virtual computers in a shared manner.

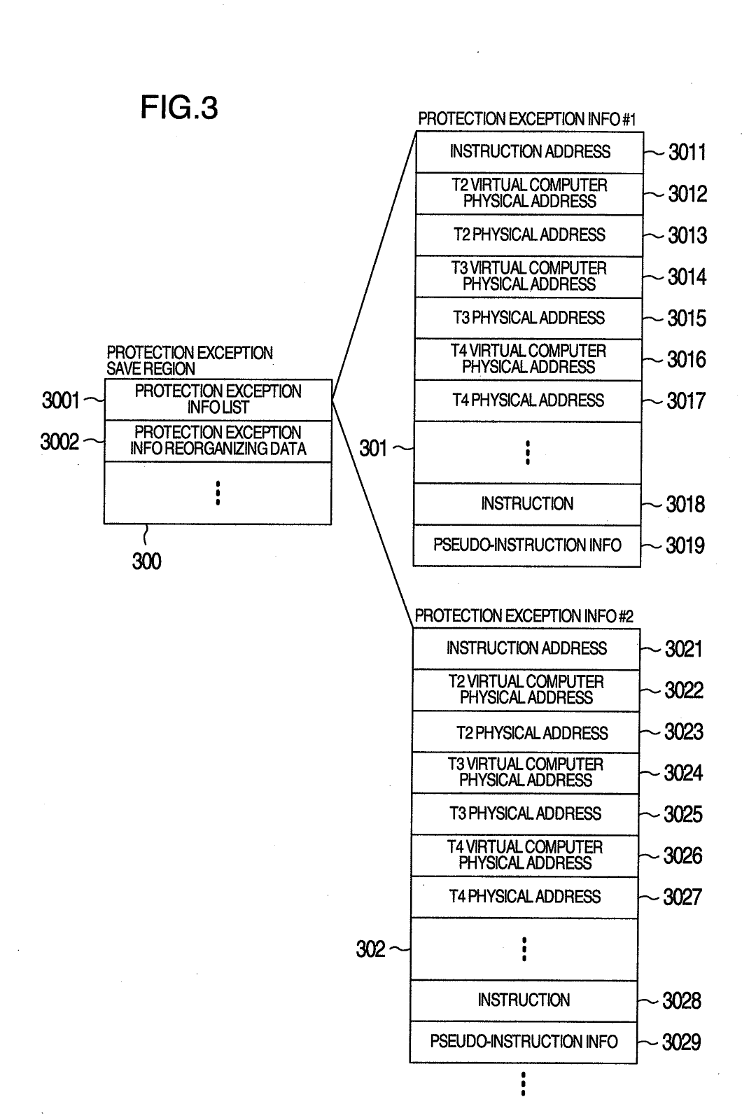

An explanation will next be given of the information as to the protection exception which is being stored in the virtual computer control unit (referred to hereinafter as the protection exception information) with reference to FIG. 3.

In the virtual computer control unit 201, there is a protection exception storage region 300. Whenever a protection exception takes places which is not registered to this protection exception storage region 300, protection exception information 301, 302 is newly generated; then, the protection exception information 301, 302 is added to a protection exception information list 3001 of the protection exception storage region 300. To make it easy to reference the registered information, the protection exception storage region 300 additionally has protection exception information consolidation data 3002 for setting in order the protection exception information 301, 302.

For holding the information of protection exception, the protection exception information 301, 302 has an instruction address of protection exception (linear address) 3011, 3021, a table virtual computer physical address (3012, 3022, 3014, 3024, 3016, 3026) per table of PT to be read when converting this instruction address (linear address) into a physical address, and a table physical address (3013, 3023, 3015, 3025, 3017, 3027) which is a result of conversion of this virtual computer physical address to the physical address.

Since these table virtual computer physical addresses and table physical addresses exist on a per-table basis, a table address of the second table of the PT is stored as the T2 virtual computer physical address 3012, 3022 and T2 physical address 3013, 3023, a table address of the third table is stored as the T3 virtual computer physical address 3014, 3024 and T3 physical address 3015, 3025, and a table address of the fourth table is stored as T4 virtual computer physical address 3016, 3026 and T4 physical address 3017, 3027. Also stored are an instruction 3018, 3028 which was read using a physical address that was converted by PT from an instruction address (linear address) and pseudo-instruction information 3019, 3029 for quasi-execution of such the instruction.

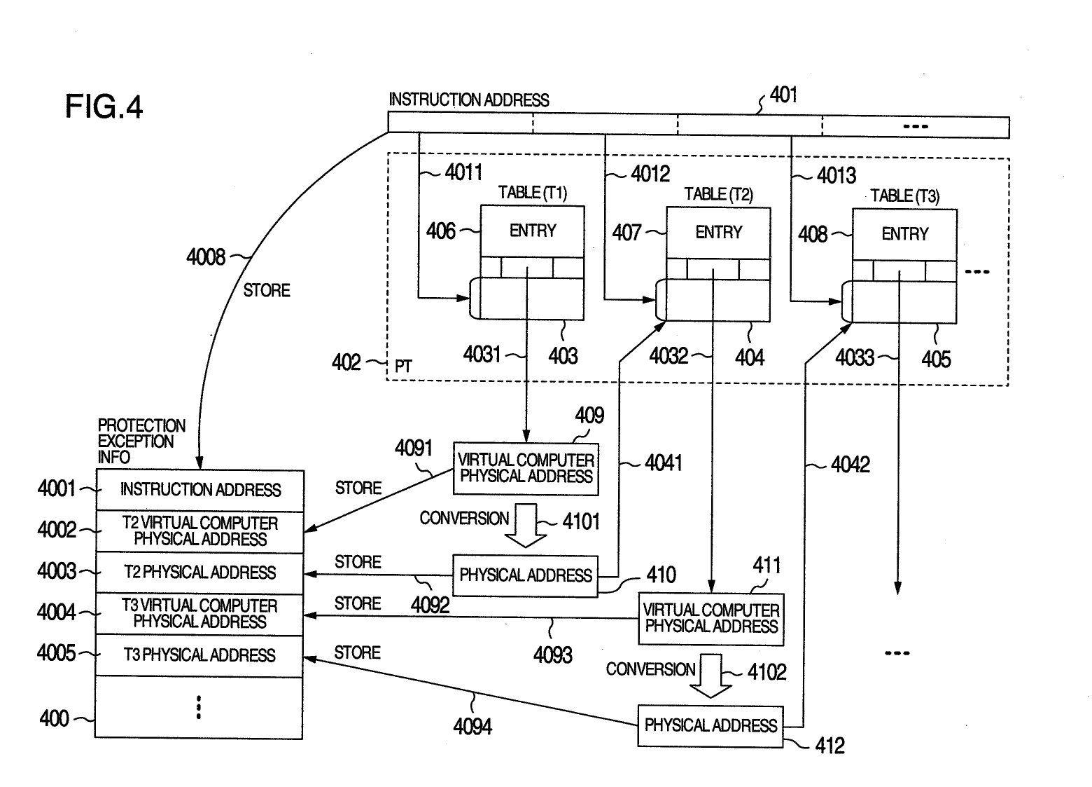

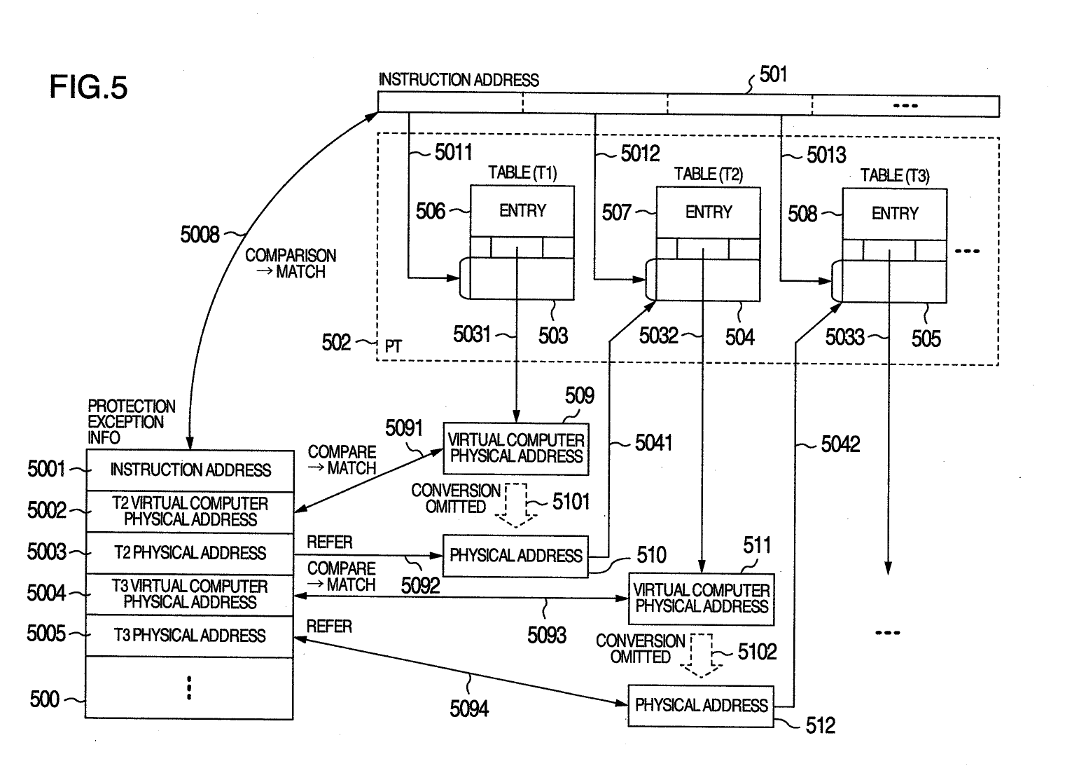

Next, an explanation will be given of an operation after generation of the protection exception processing with reference to FIGS. 4 and 5. When an instruction address is passed to the virtual computer control unit upon generation of the protection exception processing, it is first passed in the form of an instruction address (linear address). However, the virtual computer control unit is merely able to directly reference the physical memory only. In view of this, it is necessary to convert the instruction address (linear address) into an instruction address (physical address). A consecutive flow of this conversion processing will next be explained below.

First, upon occurrence of the protection exception processing, a search is conducted while letting the protection exception save region (300) be the target object, thereby to determine whether there is protection exception information which coincides with the instruction address (linear address) that became the cause of the protection exception.

FIG. 4 shows a case where any protection exception information coinciding therewith does not exist. In this case, the protection exception information is out of use; instead, the virtual computer physical address is converted to a physical address to thereby read the PT. In addition, the information of the protection exception to be processed at this time is stored or included in the protection exception information, for permitting later consultation when the same instruction will next come.

FIG. 5 shows a case where there exists the protection exception information coinciding therewith. In this case, such the protection exception information is used to read the PT after having converted the virtual computer physical address and physical address.

Here, an explanation will first be given of an operation in the case where any protection exception information which coincides with the instruction address (linear address) that became the cause of the protection exception is absent in the protection exception save region (300)—i.e., in the case of the protection exception information of the instruction that became the protection exception is not registered yet. It is noted here that examples of the situation that the protection exception information does not exist in the protection exception save region include an event for start-up of the computer system.

First, an instruction address (linear address) 401 is stored or included in an instruction address 4001 of protection exception information 400 (as indicated by arrow 4008 in FIG. 4).

Then, the instruction address (linear address) 401 is used to read a PT 402, in which the OS on a virtual computer and a process operating on the OS are generated, until a physical address of the instruction is determined.

Next, based on entry information 406 which was read from the head part of first table (T1) 403 with one part of the instruction address (linear address) 401 being as an index 4011, a top address 409 of next table (T2) 404 is taken out (4031).

This top address is a virtual computer physical address 409; so, it is impossible to access and reference the table (T2) 404 in its “intact” form. Consequently, the virtual computer physical address 409 is converted to a physical address 410 (as indicated by thick arrow 4101 in FIG. 4). For this address conversion in the process 4101, it is necessary to consult a correspondence table between every available virtual computer physical memory and every physical memory. Accordingly, the processing amount required for this conversion is very large.

The physical address 410 that was obtained by the conversion and the virtual computer physical address 409 before the conversion are stored as the top address of the table (T2) 404 at a T2 physical address 4002 and T2 virtual computer physical address 4001 of the protection exception information 400 (as indicated by arrows 4091 and 4092).

Next, based on entry information 407 which was read out of the physical address 410 that indicates the head of the table (T2) 404 (see line 4041) with one part of the instruction address (linear address) 401 being as an index 4012, a top address 411 of next table (T3) 405 is taken out.

This top address 411 is a virtual computer physical address 411; so, this address is converted to a physical address 412 (as indicated by thick arrow 4102). A conversion method therefor is the same as that used to obtain the top address of the table (T2) 404. For the conversion in the event 4012 to be performed here also, it is required to consult or reference the correspondence table between every virtual computer physical memory and every physical memory. Due to this, the processing amount needed for this conversion increases at all times.

Next, a physical address 412 which was obtained by the conversion and the virtual computer physical address 411 before the conversion are stored as the top address of the table (T3) 405 at a T3 physical address 4004 and T3 virtual computer physical address 4003 of the protection exception information 400 (as shown by arrows 4093 and 4094).

Next, based on entry information 408 which was read from the physical address 412 that indicates the head of the table (T3) 405 (see line 4042) with one part of the instruction address (linear address) 401 being as an index 4013, a top address of next table is taken out (4033). The above-stated processing will be repeated until a physical address corresponding to the instruction address (linear address) is finally computed.

An explanation will next be given, using FIG. 5, of an operation in a case where there is the protection exception information that coincides with the instruction address (linear address) that became the cause of the protection exception in the protection exception save region 300—i.e., in case the protection exception information of the instruction that became a protection exception has already been registered. More specifically, this is an operation to be performed after the information of such protection exception is stored or included in the protection exception information 400 in the example of FIG. 4.

In case the protection exception information which coincides with the instruction address (linear address) that became the cause of protection exception is present in the protection exception save region 300, this protection exception information is used to convert the virtual computer physical address and physical address to thereby read the PT.

Note here that in the case of the physical address being computed at this time, it is necessary, in order to verify whether the protection exception information and the PT to be referenced in this event coincides with each other, to compare together the virtual computer physical address that is stored in the protection exception information and the virtual computer physical address that is registered to the table of PT to thereby determine whether these coincide with each other. In a case where a result of this judgment indicates that these fail to coincide with each other even at one portion thereof, this protection exception information is not used; instead, the virtual computer physical address is converted to a physical address to thereby read the PT, followed by registration of new protection exception information.

After having affirmed through comparison that an instruction address (linear address) 501 coincides with an instruction address 5001 of protection exception information 500 (as indicated by arrow 5008), the instruction address (linear address) 501 is used to read the PT 502 in which the OS on vertical computer and a process operating on the OS are generated until a physical address of instruction is obtained.

A top address 509 of the next table (T2) 504 is taken out of entry information 506 which was read from the head of the first table (T1) 503 with a part of the instruction address (linear address) being as an index 5011 (as shown by arrow 5031).

This top address 509 is a virtual computer physical address, which is then subjected to comparison with a T2 virtual computer physical address 5002 which is stored or included in the protection exception information 500. If the virtual computer physical address 509 which is the top address of the table (T2) 504 and the T2 virtual computer physical address 5002 that is stored or included in the protection exception information 500 coincide with each other, a T2 physical address 5003 which is saved in the protection exception information 500 is used as the top address of the next table (T2) 504. Whereby, the conversion of the virtual computer physical address into a physical address is omitted (as shown by thick dash-line arrow 5101).

Next, a top address 511 of the next table (T3) 505 is taken out of entry information 507 which was read from the physical address 510 indicating the head of the table (T2) 504 (see arrow 5041) with a part of the instruction address (linear address) 501 being as an index 5012 (as shown by arrow 5032).

This top address 511 is a virtual computer physical address, which is then compared with a T3 virtual computer physical address 5004 which is stored or included in the protection exception information 500. If the virtual computer physical address 511 which is the top address of the table (T3) 505 and the T3 virtual computer physical address 5004 that is stored in the protection exception information 500 coincide with each other, a T3 physical address 5005 which is saved in the protection exception information 500 is used as the top address of the next table (T3) 505. This contributes to elimination of the conversion of the virtual computer physical address into a physical address.

Next, a top address of the next table is taken out of entry information 508 which was read from the physical address 512 indicating the head of the table (T3) 505—see arrow 5042—with a part of the instruction address (linear address) being as an index 5013 (as shown by arrow 5033). This process will be repeated until a physical address corresponding to the instruction address (linear address) is finally calculated.

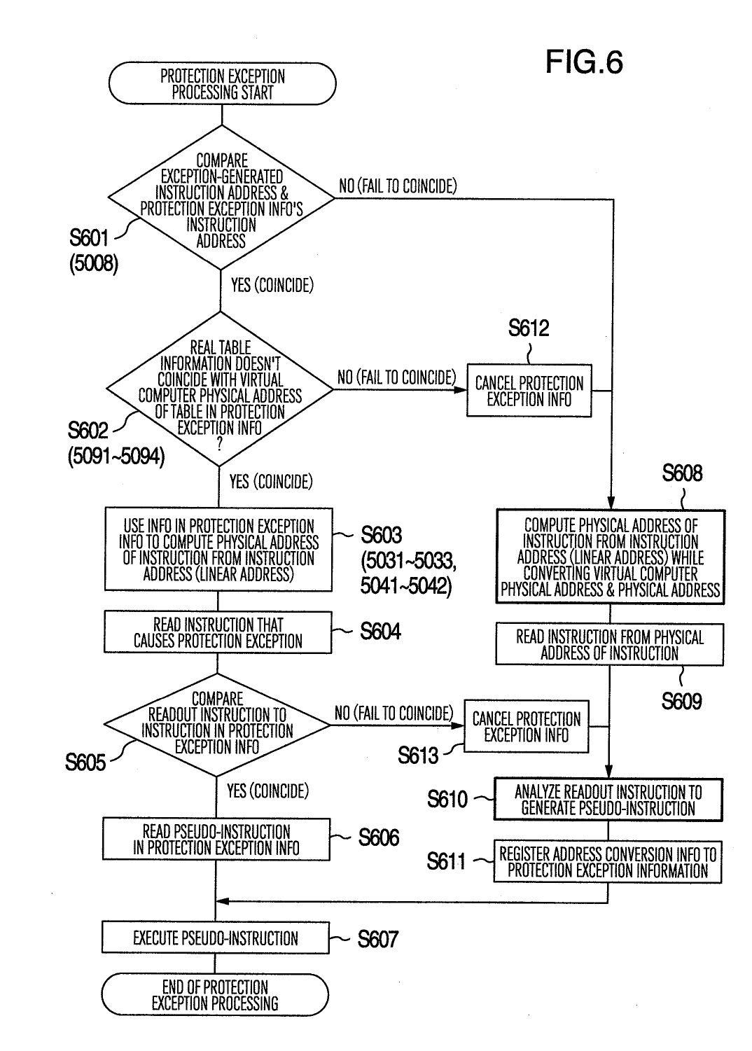

Here, a detailed explanation of a processing operation during the protection exception processing in the computer system incorporating the principles of this invention, which has been described using FIGS. 4 and 5, will be given with reference to a flowchart shown in FIG. 6.

First, when protection exception processing is generated, a search is conducted with the address of an instruction that has generated such exception being as a key to thereby determine whether the protection exception information exists in the protection exception save region (at step S601 of FIG. 6 as shown by arrow 5008 in FIG. 5). Regarding an instruction which is not registered to the protection exception save region, the instruction address (linear address) is used as a key to read the PT in which the OS on vertical computer and a process operating on the OS are generated.

At this time, the physical address which is being used within the virtual computer and the physical address on the real computer are different from each other; so, an attempt is made to consult or reference the correspondence table between every available virtual computer physical memory and every physical memory whenever reading each table of the PT, thereby converting the virtual computer physical address into a physical address in the way stated supra. This conversion will be repeated to read the PT of virtual computer to thereby compute a physical address of the instruction from the instruction address (linear address) (at step S608).

An instruction that is stored in the physical memory is read out of the physical address of the instruction (at step S609).

Next, in view of the fact that the instruction thus read is a binary code string, the pattern matching of every instruction owned by the CPU and the instruction analysis in conformity to CPU architecture are implemented by the virtual computer control unit with respect to the binary of the instruction, thereby converting the instruction that has generated an exception into a form which is executable by the virtual computer control unit (at step S610). A result of this conversion is called the pseudo-instruction.

This pseudo-instruction, the instruction address (linear address), the instruction, the virtual computer physical address that was used when reading each table of PT and the physical address that is the conversion result are held as new protection exception information (at step S611). Thereafter, the pseudo-instruction is executed. Those operations other than the search of protection exception information and the storage of such protection exception information are the same as the operations in the case of this invention being not applied.

An explanation will next be given of a case where protection exception information having the address of the instruction that generated such exception is found by the search within the protection exception save region (S601, 5008) when protection exception processing takes place.

If the protection exception information is found which has information with its address equal to the address of the instruction that generated the exception, then calculate a physical address of the instruction from the instruction address (linear address) (at steps S602 and S603).

To calculate the physical address of the instruction from the instruction address (linear address), it is a must to read the PT that was generated on the virtual computer while converting the virtual computer physical address and physical address as has been stated previously. To do this, if the virtual computer physical address which was actually read out of the PT's table and the virtual computer physical address relating to this table within the protection exception information are equivalent to each other, the physical address relating to this table in the protection exception information is used to read the next table (S602, 5091-5094).

This process will be repeated to read the PT of virtual computer to thereby compute the physical address of the instruction from the instruction address (linear address). Whereby, conversion of the table's virtual computer physical address and the physical address is performed; then, read the table, and calculate the physical address of the instruction from the instruction address (linear address) (S603, 5031-5033, 5041-5042).

It should be noted that in a case where the virtual computer physical address which was actually read out of the PT's table and the virtual computer physical address relating to this table within the protection exception information are not equivalent to each other, cancellation or “withdrawal” is performed with respect to this protection exception information (S612).

The physical memory is read from the physical address of the instruction, thereby to take out or “extract” the binary of the instruction (S604).

Next, the instruction binary thus taken out and the binary of the instruction which is held in the protection exception information are compared to each other (S605).

If these coincide with each other, the pseudo-instruction of an analysis result of this instruction is also equivalent; thus, the pseudo-instruction being held within the protection exception information is used (S606) to execute the pseudo-instruction (S607).

In case it is not equivalent to the binary of the instruction within the protection exception information, this protection exception information is cancelled (S613), followed by execution of command analysis of the binary of this instruction (S610).

As apparent from the foregoing, according to the computer system incorporating the principles of this invention, even a system in which the time taken for address conversion and instruction analysis is dominative with respect to the processing time of the virtual computer control unit is arranged to execute the process steps S601 to S607 and use the protection exception information that is registered to the protection exception region and, thus, it is possible to omit the processing that is significant in execution processing amount, such as consulting the correspondence table between every virtual computer physical memory and every physical memory at the step S608 as an example, thereby enabling suppression of the processing amount of the entire system. Especially, in regard to a virtual device which is large in frequency of usage and which is repeatedly referenced, it is possible to receive the advantage of this effect more largely.

The above-stated processing in the embodiment of this invention is configurable from a software program or programs, which is/are executable by the CPU as built in the system embodying the invention. Alternatively, these programs are providable by storing them in a recording medium, such as floppy diskettes (FDs), a compact disc read-only memory (CD-ROM), digital versatile disk (DVD) or else, or still alternatively, providable in the form of digital information that is downloadable via a network.

In cases where this invention is applied, for example, to virtualization of a high precision event timer (HPET) which is employed in high-end servers with built-in virtualization software, the reusability of the protection exception information is made higher to thereby enable elimination of processing amount-increased address conversion and instruction analysis in view of the fact that the HPET has a timer register and HPET table in a virtual computer physical memory space and that access to the HPET which is a timer is repeated again and again at fixed time intervals in response to receipt of the same instruction. By omitting such large amount of processing in this way, it is possible to drastically reduce the processing amount of protection exception processing part. In addition, in a read/write session of a register, such as a memory-mapped IO or the like, it often occurs that the same instruction is issued while letting it be shared among a plurality of processes. In this case also, applying this invention makes it possible to lower the processing amount thereof.

Owing to the above-stated contributing factors, in the case of this invention being applied, it was made sure that the processing of a protection exception occurring on a virtual computer is improvable in processing speed to the extent that it becomes about two to eight times greater than that in the prior art.

It should be further understood by those skilled in the art that although the foregoing description has been made on embodiments of the invention, the invention is not limited thereto and various changes and modifications may be made without departing from the spirit of the invention and the scope of the appended claims.

1. A computer apparatus having one or more than one physical processor, a physical memory, a virtual computer which logically divides the physical processor and the physical memory for using divided ones as a virtual processor and a virtual computer physical memory, and a virtual computer control unit for controlling said virtual computer, wherein
said virtual computer comprises said virtual processor, said virtual computer physical memory, a page table having a correspondence relationship of address information of an address space of said virtual computer physical memory and address information of an address space of said physical memory, and a protection object table for management of address information of a presently protected address space in said virtual computer physical memory,
said virtual computer control unit comprises a protection exception processing unit for executing protection exception processing in a case where access is given to the address space being managed by said protection object table, a protection exception save region for storing therein protection exception information concerning the protection exception processing executed, an address conversion unit for converting an address of said virtual computer physical memory and an address of said physical memory, and an instruction analysis unit, and
upon execution of said protection exception processing, said protection exception processing unit compares an instruction address which generated the protection exception processing and an instruction address of protection exception information saved in said protection exception save region and, when the instruction address which generated the protection exception processing and the instruction address of said protection exception information coincide with each other, said protection exception processing unit executes said protection exception processing with a pseudo-instruction which is included in the protection exception information of the identical instruction address.

2. The computer apparatus according to claim 1, wherein when said instruction address which generated the protection exception processing and said instruction address of the protection exception information fail to coincide with each other, said protection exception processing unit operates, based on said instruction address which generated the protection exception processing, to take the address of said virtual computer physical memory out of said page table,
said address conversion unit converts this taken-out address of said virtual computer physical memory into a physical memory address of an instruction,
said protection exception processing unit reads an instruction from said physical memory with the converted physical memory address of the instruction,
said instruction analysis unit analyzes the instruction to thereby generate a pseudo-instruction, and
said protection exception processing unit executes protection exception processing with said pseudo-instruction.

3. The computer apparatus according to claim 2, wherein when said instruction address which generated the protection exception processing and said instruction address of the protection exception information fail to coincide with each other, said protection exception processing unit operates, based on said instruction address which generated the protection exception processing, to store the generated pseudo-instruction in said protection exception information.

4. The computer apparatus according to claim 3, wherein said protection exception processing unit further stores said instruction address which generated the protection exception processing, the address of said virtual computer physical memory as taken out of said page table, said physical memory address of the instruction and said instruction in said protection exception information.

5. The computer apparatus according to claim 1, wherein said page table has a plurality of tables with at least part of instruction address being queued as an index, and wherein
said protection exception processing unit compares together a virtual computer physical address which is read out of a certain table of said page table and a virtual computer physical address which is included in protection exception information of said identical instruction address,
when a result of comparison indicates equivalency, said protection exception processing unit reads a table next to said certain table with a physical address which is included in protection exception information of said identical instruction address, and
when the result of comparison indicates lack of equivalency, said protection exception processing unit cancels said protection exception information.

6. The computer apparatus according to claim 5, wherein after having cancelled said protection exception information, said protection exception processing unit takes, based on said instruction address which generated the protection exception processing, an address of said virtual computer physical memory out of said page table,
said address conversion unit converts the taken-out address of said virtual computer physical memory into a physical memory address of instruction,
said protection exception processing unit reads an instruction from said physical memory with the physical memory address of instruction thus converted,
said instruction analysis unit analyzes the instruction and generates a pseudo-instruction, and
said protection exception processing unit executes protection exception processing with the pseudo-instruction.

7. The computer apparatus according to claim 5, wherein said protection exception processing unit takes a binary of instruction out of said physical memory, compares together the binary of instruction which was taken out of said physical memory and a binary of instruction being held within said protection exception information, executes, when a comparison result indicates equivalency, a pseudo-instruction by using the pseudo-instruction being held in said protection exception information, and, when the comparison result indicates lack of equivalency, cancels said protection exception information.

8. The computer apparatus according to claim 7, wherein after having cancelled said protection exception information, said instruction analysis unit analyzes said binary of instruction to thereby generate a pseudo-instruction, and wherein said protection exception processing unit execute protection exception processing with the pseudo-instruction.

9. The computer apparatus according to claim 1, wherein said physical processor and said physical memory are divided by said virtual computer control unit as said virtual processor and said virtual computer physical memory on a plurality of virtual computers.

10. A control method for use in a computer apparatus having one or more than one physical processor, a physical memory, a virtual computer which logically divides the physical processor and the physical memory for using divided ones as a virtual processor and a virtual computer physical memory, and a virtual computer control unit for controlling said virtual computer, wherein
said virtual computer comprises said virtual processor, said virtual computer physical memory, a page table having a correspondence relationship of address information of an address space of said virtual computer physical memory and address information of an address space of said physical memory, and a protection object table for management of address information of a presently protected address space in said virtual computer physical memory,
said virtual computer control unit comprises a protection exception processing unit for executing protection exception processing in a case where access is given to the address space being managed by said protection object table, a protection exception save region for storing therein protection exception information concerning the protection exception processing executed, an address conversion unit for converting an address of said virtual computer physical memory and an address of said physical memory, and an instruction analysis unit, and
upon execution of said protection exception processing, said protection exception processing unit compares an instruction address which generated the protection exception processing and an instruction address of protection exception information saved in said protection exception save region and, when the instruction address which generated the protection exception processing and the instruction address of said protection exception information coincide with each other, said protection exception processing unit executes said protection exception processing with a pseudo-instruction which is included in the protection exception information of the identical instruction address.

11. The control method according to claim 10, wherein when said instruction address which generated the protection exception processing and said instruction address of the protection exception information fail to coincide with each other, said protection exception processing unit operates, based on said instruction address which generated the protection exception processing, to take the address of said virtual computer physical memory out of said page table,
said address conversion unit converts this taken-out address of said virtual computer physical memory into a physical memory address of an instruction,
said protection exception processing unit reads an instruction from said physical memory with the converted physical memory address of the instruction,
said instruction analysis unit analyzes the instruction to thereby generate a pseudo-instruction, and
said protection exception processing unit executes protection exception processing with said pseudo-instruction.

12. The control method according to claim 11, wherein when said instruction address which generated the protection exception processing and said instruction address of the protection exception information fail to coincide with each other, said protection exception processing unit operates, based on said instruction address which generated the protection exception processing, to store the generated pseudo-instruction in said protection exception information.

13. The control method according to claim 12, wherein said protection exception processing unit further stores said instruction address which generated the protection exception processing, the address of said virtual computer physical memory as taken out of said page table, said physical memory address of the instruction and said instruction in said protection exception information.

14. The control method according to claim 10, wherein said page table has a plurality of tables with at least part of instruction address being queued as an index, and wherein
said protection exception processing unit compares together a virtual computer physical address which is read out of a certain table of said page table and a virtual computer physical address which is included in protection exception information of said identical instruction address,
when a result of comparison indicates equivalency, said protection exception processing unit reads a table next to said certain table with a physical address which is included in protection exception information of said identical instruction address, and
when the result of comparison indicates lack of equivalency, said protection exception processing unit cancels said protection exception information.

15. The control method according to claim 14, wherein after having cancelled said protection exception information, said protection exception processing unit takes, based on said instruction address which generated the protection exception processing, an address of said virtual computer physical memory out of said page table,
said address conversion unit converts the taken-out address of said virtual computer physical memory into a physical memory address of instruction,
said protection exception processing unit reads an instruction from said physical memory with the physical memory address of instruction thus converted,
said instruction analysis unit analyzes the instruction and generates a pseudo-instruction, and
said protection exception processing unit executes protection exception processing with the pseudo-instruction.

16. The control method according to claim 14, wherein said protection exception processing unit takes a binary of instruction out of said physical memory, compares together the binary of instruction which was taken out of said physical memory and a binary of instruction being held within said protection exception information, executes, when a comparison result indicates equivalency, a pseudo-instruction by using the pseudo-instruction being held in said protection exception information, and, when the comparison result indicates lack of equivalency, cancels said protection exception information.

17. The control method according to claim 16, wherein after having cancelled said protection exception information, said instruction analysis unit analyzes said binary of instruction to thereby generate a pseudo-instruction, and wherein said protection exception processing unit executes protection exception processing with the pseudo-instruction.

18. The control method according to claim 10, wherein said physical processor and said physical memory are divided by said virtual computer control unit as said virtual processor and said virtual computer physical memory on a plurality of virtual computers.
